(19) United States
(12) Patent Application Publication
(10) Pub. No.: US 2013/0171901 A1
(43) Pub. Date: Jul. 4, 2013

(54) ADHESIVE COMPOUND FOR HOT-SEALING INSERTS

(71) Applicants: Heike Bartl, Weinheim (DE); Cornelia Kinscherf, Moerlenbach (DE); Oliver Staudenmayer, Weinheim (DE); Ulrich Scherbel, Munich (DE)

(72) Inventors: Heike Bartl, Weinheim (DE); Cornelia Kinscherf, Moerlenbach (DE); Oliver Staudenmayer, Weinheim (DE); Ulrich Scherbel, Munich (DE)

(73) Assignee: CARL FREUDENBERG KG, Weinheim (DE)

(21) Appl. No.: 13/820,168

(22) PCT Filed: Jul. 21, 2011
(86) PCT No.: PCT/EP2011/003651

§ 371 Date: Mar. 1, 2013

(30) Foreign Application Priority Data
Sep. 2, 2010 (DE) 10 2010 044 265.8

(51) Int. Cl. C09J 177/06

(52) U.S. Cl. CPC C09J 177/06
USPC 442/291; 525/183; 524/514; 156/330.9; 156/249; 442/304; 442/394; 428/355 BL; 450/55

(57) ABSTRACT

An adhesive compound for a hot-sealing insert is provided, as are an insert that contains this adhesive compound, and a method for fixing the insert. The adhesive compound has a thermoplastic hot-melt adhesive (A) that is not adhesive at room temperature and a pressure sensitive adhesive (B) that is adhesive at room temperature.

### CROSS-REFERENCE TO RELATED APPLICATIONS

This application is a U.S. national phase application under 35 U.S.C. §371 of International Application No. PCT/EP2011/003651, filed on Jul. 21, 2011, and claims benefit to German Patent Application No. DE 10 2010 044 265.8, filed Sep. 2, 2010. The International Application was published in German on Mar. 8, 2012 as WO 2012/028229 A1 under PCT Article 21(2).

### FIELD

The invention relates to an adhesive compound for fusible interfacing and to interfacing provided with this adhesive compound as well as to a method for fusing the interfacing.

### BACKGROUND

Adhesive textile interlining materials, which are also referred to as fusible interfacing or heat-activated interfacing, are used primarily in garments of all types, where they are employed for shaping and/or stabilizing textile fabrics such as, for example, textile outer fabrics.

Interfacings refer to textile fabrics such as wovens, knits or nonwovens onto which a heat-activated thermoplastic adhesive compound has been applied and which form an adhesive and permanent bond with another textile fabric upon exposure to heat, pressure and time, resulting in wear fastness characteristics that match those of the textile fabric. Thus, the bond to a garment fused with fusible interfacing is supposed to withstand the usual garment care treatments, namely, laundering and dry-cleaning, and should continue to adhere effectively thereafter. Moreover, the adhesive compound should not soak through to the outside of the outer fabric and should not be visible or palpable there since this would impair the appearance and feel of the fused textile.

Conventional heat-activated adhesives for fusible interfacing and methods for applying the heat-activated adhesives onto the interfacing substrate fabric are described, for example, by Sroka in “Handbuch der textilen Fixieranlagen” [Manual of textile fusible interfacing], 3^{rd} expanded edition, 1993, published by Hartung-Gorre Verlag, Constance, Germany, pages 178 to 254. The application methods for adhesive compounds most commonly employed for fusible interfacing are paste-dot coating, powder-dot coating and double-dot coating. The heat-activation capability of the adhesive compounds used in these methods is achieved with pulverulent heat-activated adhesives, usually copolyamides, copolyesters and polyolefins. These adhesive compounds are glued to the textile outer fabrics under exposure to pressure and heat over a certain predetermined period of time. The parameters can be freely selected within certain limits. Generally speaking, the fusing temperatures are within the range from 60° C. to 165° C. [140° F. to 329° F.]. In order to prevent damage to the textile outer fabric, higher fusing temperatures are not recommended. The fusing is carried out using familiar fusing aggregates, for instance, by means of a pressing method such as through-feed pressing or board pressing, or else with a hand iron. The fusing time during which heat is applied generally ranges from 5 seconds to 120 seconds. As a rule, the pressure is within the range from 0 N/m² to 8×10⁵ N/m². The parameters that are of significance for the fusing of fusible interfacing, namely, temperature, time, pressure and aggregate, are referred to as the fusing conditions.

Developments in fashion account for the fact that numerous outer fabrics are found on the market that cannot be satisfactorily fused with prior-art fusible interfacing provided with a conventional heat-activated adhesive.

Outer fabrics having a very smooth and/or coated and/or water-repellant and/or highly compacted surface are considered to be fabrics that are difficult to fuse since, when the prior-art adhesive compounds on the basis of heat-activated thermoplastic adhesives based on copolyamide, copolyester or polyethylene powders are used, the fabrics display inadequate results with respect to at least one of the following properties: sufficient adhesion (delamination strength), care treatment-resistance, appearance or feel. The delamination strength and the care treatment-resistance are problematic in the case of the above-mentioned fabrics. Many smooth fabrics made of nylon or silk as well as outer fabrics with a water-repellant coating of the type used, for instance, for rain jackets or imitation leather are considered to be fabrics that are difficult to fuse.

However, even very thin, lightweight outer fabrics, which usually have an open, perforated, porous material structure, are considered to be fabrics that are difficult to fuse. These include chiffon fabrics as well as cotton or linen fabrics with an open weave. The problem with these fabrics when the prior-art heat-activated thermoplastic adhesives on the basis of copolyamide, copolyester or polyethylene powders are used is that, during the fusing with the interfacing, which takes place under the effect of pressure and heat, the adhesive compound soaks through the outer fabric, that is to say, through its holes, where it is visible after cooling off and can be felt as a hardened spot. The prior-art heat-activated adhesives cause shininess on the outside of the outer fabric, or else the dot of heat-activated adhesive is noticeable as a color difference or smudge on the outer fabric.

Therefore, after being fused at 120° C. [248° F.] for 12 seconds at 2.5 bar using a fusing press of the type Veit-Kannegiesser Multistar DX 1000 C/T/TA, the outer fabrics described above cannot be fused with the prior-art adhesive compounds in way that would yield a satisfactory appearance and feel along with good care treatment-resistance (delamination strength after laundering at 60° C. [140° F.] and dry-cleaning) and good adhesion (delamination strength) of at least 1.5 N measured according to DIN 54310:1980), with a divergent specimen size (test specimen: 150 mm×50 mm, test fabric: 160 mm×60 mm) and a drawing-off speed of 150 mm/min.

When classic interfacings coated with heat-activated adhesive are used, three-dimensional parts such as canvas-like structures that are used in men's suit jackets often can only be made and processed with unsatisfactory results and using a very laborious method. For the processing, the interfacing first has to be thermally fused in a fusing press while lying flat. Owing to the special fiber composition and the compacted surface, the delamination strength values that can be reached for canvas-like structures are often inadequate. The interfacing can become detached during care treatment or steaming, which causes problems in use. For this reason, sewn-in interlining that is attached by means of seams is often employed for canvas-like structures, or else additional sewing processes are carried out to affix the interfacing when fusible interfacing is employed. The seams are laborious to produce, and in addition, they can show through or create folds, detrimentally affecting the appearance of the part. Moreover, after the interfacing has been fused, in order to create the canvas-like structure, there is a need to carry out another work step on a shaping press, a process in which the part is given its three-dimensional shape, usually by means of steaming. This multi-step work method is costly and yet often does not yield a flawless result. During the care treatment of the garment, especially after dry-cleaning, the dimensional stability of canvas-like structures fused with classic interfacing coated with heat-activated adhesives is insufficient. They lose their three-dimensional shape during the dry-cleaning process, which has a detrimental effect on the appearance and quality of the finished garment.

An aspect of the invention is based on the objective of putting forward an adhesive compound for fusible interfacing as well as interfacing provided with this adhesive compound, by means of which a good appearance and feel, along with a good delamination strength, even after care treatments, such as laundering at 60° C. [140° F.] and dry-cleaning, are ensured for the thermal fusing of fabrics that are difficult to fuse under the conventional conditions for fusible interfacing. In particular, the adhesive compound should not be visible or palpable as a hardened place on the outside of the outer fabric after the fusing process. Moreover, the fusible interfacing provided with the adhesive compound according to the invention should lend itself for being processed and positioned.

Particularly in the case of canvas-like structures, the possibility should exist to impart them with sufficient delamination strength and a better appearance through the use of interfacing provided with the adhesive compound according to the invention, and also to simplify the process for creating such canvas-like structures.

### SUMMARY

An objective of the present invention is achieved by an adhesive compound for fusible interfacing, comprising: (A) a heat-activated thermoplastic adhesive (component A) that is not sticky at room temperature; and (B) a contact adhesive (pressure-sensitive adhesive) that is tacky at room temperature (component B), wherein a proportion of component (A) is 5% to 40% by weight, preferably 10% to 30% by weight, relative to a total weight of a non-dried adhesive compound comprising all components, and wherein a proportion of component (B) is 30% to 95% by weight liquid, relative to the total weight of the non-dried adhesive compound comprising all of the components.

### DETAILED DESCRIPTION

According to an aspect of the invention, an adhesive compound for fusible interfacing containing a heat-activated thermoplastic adhesive (component A) is characterized in that, as an additional component, it contains a contact adhesive (pressure-sensitive adhesive) that is tacky at room temperature (component B), whereby the proportion of component (A) amounts to 5% to 40% by weight, preferably 10% to 30% by weight, relative to the total weight of the non-dried adhesive compound containing all of the components, and the proportion of component (B) amounts to 30% to 95% by weight liquid, preferably 50% to 90% by weight liquid, relative to the total weight of the non-dried adhesive compound containing all of the components.

The heat-activated thermoplastic adhesive (component A) is not sticky at room temperature.

Contact adhesives and their properties are well known and are described, for example, by Dieter Distler in “WäBrige Polymerdispersionen, Synthese, Eigenschaften and Anwendungen” [Aqueous polymer dispersions, synthesis, properties and applications], published by Wiley-VCH GmbH & Co KGA, of Weinheim, Germany, 1999, Chapters 7 to 7.2, pages 125 to 150. Generally speaking, contact adhesives are glued at room temperature under pressure onto substrates that, for the most part, are not of a textile nature. They are normally applied onto paper or films, and thus employed, for instance, as self-adhesive labels or adhesive films. As a rule, they are slightly tacky to highly sticky at room temperature. In the known applications, the gluing takes place only upon exposure to pressure, without the use of heat.

Contact adhesives are actually not well-suited for use as adhesive compounds for fusible interfacing. It could be expected that interfacing materials having contact adhesives as the adhesive compounds only yield insufficient results in terms of the desired properties such as delamination strength, laundering resistance, dry-cleaning resistance, appearance and feel. In particular, it could be expected that the adhesive properties of such adhesive compounds are inadequate for laundering and/or dry-cleaning, so that, after such treatments, they would detach from the outer fabric or else the interfacing would shift, which is not acceptable for applications in the textile sector. Under the effect of heat, for example, at temperatures that are commonly employed for the fusing of textile outer fabrics, the contact adhesives become runny and soak through to the outside of the outer fabrics that are to be fused. They would be visible or palpable after the fusing, so that the appearance and feel after the fusing would not be satisfactory. Moreover, highly sticky adhesives have to be provided with a cover material in order to be protected against dirt, and this cover material then has to be removed again during the processing. Due to this removal step and the high stickiness, they would be difficult to position on the outer fabric and thus difficult to process, which would prevent them from being used for fusible interfacings, especially those that are to be glued onto very thin, lightweight textile substrates as well as for those that are designed for use with a porous material structure.

It has now been surprisingly found that adhesive compounds consisting of a heat-activated thermoplastic adhesive that is not sticky at room temperature and of a contact adhesive that is tacky at room temperature as the active component are well-suited as adhesive compounds for fusible interfacing materials and they can especially be used successfully, even for the above-mentioned difficult textile substrates.

A particularly surprising aspect in this context is that specially selected aqueous polymer dispersions or polymer emulsions from the group of contact adhesives containing additional heat-activated thermoplastic adhesives on the basis of copolyamide, copolyester or polyethylene powders make it possible to produce a heat-activated adhesive compound for fusible interfacing which, in spite of the high percentage of 30% by weight liquid, or more of contact adhesive components (relative to the total weight of the non-dried adhesive compound containing all of the components) can be glued under the conventional conditions for fusible interfacings (pressure, time, temperature) to thin, lightweight textile outer fabrics as well as to those having a porous material structure, yielding a good delamination strength even after laundering and dry-cleaning, while also providing a good appearance and feel, without the adhesive compound being visible or palpable after being fused onto the outer fabric, in addition to which the interfacing is easy to position and process. Moreover, it could be demonstrated that, even when a contact adhesive that is stickier at room temperature is used, it is nevertheless possible to produce adhesive compounds that are easy to process, that are only slightly tacky and that can thus be easily positioned. This is especially possible when, prior to the drying, heat-activated thermoplastic adhesive powder is sprinkled onto a paste dot containing the contact adhesive and, if applicable, additional heat-activated adhesive powder, after which the adhesive compound is dried.

Furthermore, the adhesive compounds according to the invention do not soak through, or hardly at all, to the outside of the outer fabric during fusing at the higher temperatures that are common for fusible interfacing, even when the contact adhesive component B contains a normally very runny, aqueous polymer dispersion or polymer emulsion that softens under exposure to heat. Therefore, with the fusible interfacing according to the invention, there is no hardening on the outside of the outer fabric and the appearance and feel are good.

Due to the at least slight tackiness of the contact adhesive components, one could expect the application unit or application aggregate to become sticky, which would lead to irregular application and to deterioration of the delamination strength and of the appearance of the fused garment, for instance, bubbling, after the care treatment. In spite of its high content of contact adhesive components, the adhesive compound according to the invention can be applied easily and evenly onto the width of fabric at room temperature as an aqueous paste.

Despite a maximum heat-activated adhesive content of 40% relative to the total weight of the non-dried adhesive compound containing all of the components, the adhesive compound according to the invention is not visible and cannot be perceived as shininess, color differences, glued spots or elevations on the outside of the outer fabric, even after being fused onto outer fabrics that have a porous material structure, especially when the adhesive compound has been matched to the color of the outer fabric through the addition of pigments.

When the thermal fusing is carried out properly, the adhesive compound according to the invention is sufficiently bonded to the substrate material and to the outer fabric, so that the interfacing does not shift or become detached when it undergoes care treatments such as laundering and dry-cleaning

The interfacing according to the invention can be fused at lower temperatures, pressures and/or holding times in comparison to prior-art fusible interfacing, so that it is particularly well-suited for use with temperature-sensitive and pressure-sensitive substrates, especially grain leather and synthetic leather.

The interfacing according to the invention is easy to position and can also be employed and processed more readily and over a wider range of applications as a system coated with a heat-activated adhesive, since it can be secured to the outer fabric by means of the contact adhesive prior to the thermal fusing, as a result of which it does not shift during the processing.

The interfacing according to the invention offers a wider array of application possibilities; in contrast to prior-art interfacing coated with heat-activated adhesives, the interfacing according to the invention, since it is adhesive, can be fused not only while lying flat, but also three-dimensionally, for instance, on a shaping press such as a pressing machine or on a steam-ironing dummy. This opens up new design and application possibilities, for instance, for shoulder padding, brassiere cups, canvas-like structures and preforms.

Moreover, during the thermal fusing, the interfacing according to the invention remains dimensionally stable, does not shrink more than the outer fabric and cannot shift either, thus allowing simpler processing, with fewer rejects.

In addition, the adhesive compound according to the invention can be produced easily and inexpensively, using just a few raw materials. An adhesive compound consisting of just a thickener, a contact adhesive and a heat-activated adhesive yields outstanding results, even without the additives commonly employed for heat-activated adhesive pastes such as plasticizers, ammonia, flowability auxiliaries.

In particular, the interfacing coated with the adhesive compound according to the invention permits simpler production, especially of canvas-like structures, along with a good delamination strength and improved appearance of the finished garment. Thus, already at room temperature, it is easily possible, for instance, by pressing with the hand, to attach the contact adhesive to the canvas-like structure, after which it can be fused by means of a shaping press and it then achieves a good delamination strength. Consequently, the interfacing coated with the adhesive compound according to the invention, unlike the classic heat-activated adhesive interfacing, does not have to be affixed while lying flat, but rather, can be attached to the canvas-like structure by means of the contact adhesive and therefore cannot shift, so that it can be fused in the final three-dimensional shape within the scope of steam shaping. Consequently, a separate fusing step of the type required with the classic interfacing coated with a heat-activated adhesive is not necessary. Since the interfacing displays good adhesion, there is no need for seams, which are laborious to create and which may impair the appearance of the finished part. The three-dimensional shape of a canvas-like structure made with interfacing provided with the adhesive compound according to the invention is very resistant to care treatments, especially dry-cleaning

The adhesive compound is preferably an aqueous, pasty dispersion containing 30% to 95% by weight liquid, preferably 50% to 90% by weight liquid, of the active component, relative to the total weight of the non-dried adhesive compound containing all of the components. The active component is preferably an aqueous polymer emulsion or polymer dispersion selected from among the group of synthetic contact adhesives and it can contain additives such as, for example, cross-linking agents, resins, wetting agents, thickeners and/or plasticizers.

The adhesive compound contains, aside from the aqueous polymer dispersion and/or polymer emulsion, also 5% to 40% by weight, preferably 10% to 30% by weight, relative to the total weight of the non-dried adhesive compound containing all of the components, of a heat-activated thermoplastic adhesive preferably selected from among the group consisting of copolyesters and/or copolyamides and/or polyolefins as an additional separate layer and/or as an admixture. Special preference is given to sprinkling the heat-activated thermoplastic adhesive in the form of powder onto a paste dot containing contact adhesive, and optionally additional heat-activated thermoplastic adhesives, prior to the drying of the adhesive compound.

The aqueous polymer dispersion and/or polymer emulsion is especially selected from among the group of synthetic contact adhesives. Among this group, preference is given to the use of acrylate polymers and acrylate copolymers, polymers and copolymers on the basis of acrylic acid ester, vinyl acetate, ethylene, styrene-butadiene copolymers or polyurethane contact adhesives or else mixtures thereof, which are adhesive, sticky or slightly tacky at room temperature, and which, when they are glued onto textile substrates under the fusing conditions commonly found for heat-activated adhesives, create a permanent bond that is resistant to laundering at 60° C. [140° F.] or dry-cleaning and that has a delamination strength of at least 1.5 N measured according to DIN 54310:1980, with a divergent specimen size (test specimen: 150 mm×50 mm, test fabric: 160 mm×60 mm) and a drawing-off speed of 150 mm/min, after fusing using a fusing press of the type Veit-Kannegiesser Multistar DX 1000 C/T/TA. Special preference is given to contact adhesives on the basis of styrene-butadiene copolymers and/or acrylic acid ester copolymers.

The adhesive compound according to the invention or the contact adhesive component B, which is present as an aqueous polymer dispersion or polymer emulsion onto which the optionally heat-activated thermoplastic adhesive is applied can be spread in a thickened form as a paste onto the interfacing substrate. The thickening can be brought about using a thickener. The viscosity of the paste according to Brookfield at 20° C. [68° F.] ranges from 25,000 cp to 100,000 cp.

The adhesive compound is preferably applied by means of a paste-printing method onto the width of substrate material as a paste dot or as the bottom dot within the scope of a double-dot technique.

The width of substrate material onto which the adhesive compound is applied is preferably a textile fabric, particularly preferably a nonwoven fabric, woven fabric or a knit fabric.

After the application onto the width of substrate material, water is removed from the adhesive compound. Preferably, the water is removed by means of a drying process in a hot-air dryer at 80° C. to 190° C. [176° F. to 374° F.] for 10 seconds to 120 seconds.

In a preferred embodiment of the invention, the adhesive compound is dyed with a pigment or with a colorant matching the outer fabric that is to be fused.

In a preferred embodiment, prior to the drying of the adhesive compound, the heat-activated thermoplastic adhesive is sprinkled as a powder onto a paste dot containing the contact adhesive and optionally an additional heat-activated thermoplastic adhesive.

After the drying, the adhesive compound is adhesive. After the drying, the width of substrate material coated with this adhesive compound is rolled up, optionally using a covering such as, for instance, a release paper, that is applied onto the adhesion-compound layer for protection purposes.

In a particularly preferred embodiment, the width of substrate material has a high surface smoothness on the side that has not been provided with the adhesive compound, so that it is possible to dispense with the covering.

The percentage of adhesive compound is 10% to 80% by weight, relative to the total weight of the fusible interfacing after the drying, that is to say, after evaporation of the water and storage in a climate-controlled environment for 24 hours at 20° C. [68° F.] and a relative humidity of 50%.

The adhesive compound contains, aside from the contact adhesive and optionally heat-activated thermoplastic adhesives, preferably less than 5%, at the maximum less than 25%, of additional constituents such as thickeners, pigments, flowability auxiliaries, which do not contribute to the adhesion or delamination strength.

This adhesive compound softens under the pre-specified fusing conditions that are selected for the application case. When the interfacing provided with the adhesive compound according to the invention is glued onto textile substrates under the fusing conditions commonly employed for heat-activated adhesives, after fusing using a fusing press of the type Veit-Kannegiesser Multistar DX 1000 C/T/TA, a permanent bond is created that is resistant to laundering at 60° C. [140° F.] or dry-cleaning and that has a delamination strength of at least 1.5 N measured according to DIN 54310:1980, with a divergent specimen size (test specimen: 150 mm×50 mm, test fabric: 160 mm×60 mm) and a drawing-off speed of 150 mm/min.

The fusible interfacing according to the invention is fused under the fusing conditions commonly employed for fusible interfacing, in other words, at temperatures within the range from 60° C. to 165° C. [140° F. to 329° F.] and at a pressure ranging from 0 N/m² to 8×10⁵ N/m² on conventional fusing installations.

### EXAMPLES

The production of the adhesive compound according to the invention as well as of interfacing coated with it will be described below on the basis of examples.

### Example 1

290 grams (=56% by weight, relative to the total weight of the non-dried adhesive compound containing all of the components) of an aqueous dispersion of a polymer on the basis of a self-cross-linking styrene-acrylate copolymer having a glass transition temperature Tg=2° C. [35.6° F.], a solids content of 60% and slight tackiness are added as the contact adhesive to 150 grams of water at room temperature. Then 1.5 grams of a black pigment on the basis of carbon black and 60 grams (=11.6% by weight, relative to the total weight of the non-dried adhesive compound containing all of the components) of a heat-activated adhesive on the basis of a copolyamide (melting range from 90° C. to 160° C. [194° F. to 320° F.]) are stirred into the mixture. Subsequently, 15 grams of a copolymer consisting of polyacrylate/acrylamide as an aqueous dispersion having a solids content of 33% are stirred in as the thickener. Following a stirring time of 30 minutes and a maturing time of 24 hours, the paste is printed by means of the paste-printing method (rotary screen printing) using a doctor blade through a perforated template (CP 180, hole diameter of 0.43 mm) onto a substrate fabric, which is a staple fiber nonwoven that has been thermally bonded in a PS process, that has a mass per unit area of 24 g/m², and that consists of 65% polyamide fibers and 35% polyester fibers. The printed nonwoven is dried for 60 seconds at 130° C. [266° F.] in an air-circulating oven. The coating weight of the adhesive compound after drying is 25 g/m².

### Example 2

290 grams (=56% by weight, relative to the total weight of the non-dried adhesive compound containing all of the components) of an emulsion of a polymer on the basis of a carboxyl-modified acrylic polymer having a glass transition temperature Tg=−30° C. [−22° F.], a solids content of 55% and slight tackiness are added as the contact adhesive to 150 grams of water at room temperature. Then 60 grams (=11.6% by weight, relative to the total weight of the non-dried adhesive compound containing all of the components) of a heat-activated adhesive on the basis of a copolyamide (melting range from 90° C. to 160° C. [194° F. to 320° F.]) are stirred into the mixture. Subsequently, 15 grams of a copolymer consisting of polyacrylate/acrylamide as an aqueous dispersion having a solids content of 33% are stirred in as the thickener. Following a stirring time of 30 minutes and a maturing time of 24 hours, the paste is printed by means of the paste-printing method (rotary screen printing) using a doctor blade through a perforated template (CP 180, hole diameter of 0.43 mm) onto a substrate fabric, which is a staple fiber nonwoven that has been thermally bonded in a PS process, that has a mass per unit area of 24 g/m², and that consists of 65% polyamide fibers and 35% polyester fibers. The printed nonwoven is dried for 60 seconds at 130° C. [266° F.] in an air-circulating oven. The coating weight of the adhesive compound after drying is 20 g/m².

### Example 3

145 grams (=50% by weight, relative to the total weight of the non-dried adhesive compound containing all of the components) of an aqueous dispersion of a copolymer on the basis of an acrylic acid ester (having a glass transition temperature Tg =−43° C. [−45.4° F.] (DSC), a minimum film-forming temperature of approximately <1° C. [33.8° F.], DIN ISO 2115, a solids content of 69% and high stickiness) are added as the contact adhesive to 75 grams of water at room temperature. Then 2 grams of a black pigment on the basis of carbon black and 60 grams (=20.6% by weight, relative to the total weight of the non-dried adhesive compound containing all of the components) of a heat-activated adhesive on the basis of a copolyamide (melting range from 90° C. to 160° C. [194° F. to 320° F.]) are stirred into the mixture. Subsequently, 8.5 grams of a copolymer consisting of polyacrylate/acrylamide as an aqueous dispersion having a solids content of 33% are stirred in as the thickener. Following a stirring time of 30 minutes and a maturing time of 24 hours, the paste is printed by means of the paste-printing method (rotary screen printing) using a doctor blade through a perforated template (CP 180, hole diameter of 0.43 mm) onto a substrate fabric, which is a staple fiber nonwoven that has been thermally bonded in a PS process, that has a mass per unit area of 24 g/m², and that consists of 65% polyamide fibers and 35% polyester fibers. The printed nonwoven is dried for 90 seconds at 130° C. [266° F.] in an air-circulating oven. The coating weight of the adhesive compound after drying is 20 g/m².

### Example 4

145 grams (=63% by weight, relative to the total weight of the non-dried adhesive compound containing all of the components) of an aqueous dispersion of a copolymer on the basis of an acrylic acid ester having a glass transition temperature Tg=−43° C. [−45.4° F. (DSC), a minimum film-forming temperature of approximately <1° C. [33.8° F.], DIN ISO 2115, a solids content of 69% and high stickiness are added as the contact adhesive to 75 grams of water at room temperature. Then 8.5 grams of a copolymer consisting of polyacrylate/acrylamide as an aqueous dispersion having a solids content of 33% are stirred in as the thickener. Following a stirring time of 30 minutes and a maturing time of 24 hours, the paste is printed by means of the paste-printing method (rotary screen printing) using a doctor blade through a perforated template (CP 180, hole diameter of 0.43 mm) onto a substrate fabric, which is a staple fiber nonwoven that has been thermally bonded in a PS process, that has a mass per unit area of 24 g/m², and that consists of 100% polyester fibers. The coating weight of the paste dot that is still moist is 44 g/m². Subsequently, a pulverulent thermoplastic copolyamide (melting range from 90° C. to 160° C. [194° F. to 320° F.]) is sprinkled as the heat-activated thermoplastic adhesive component onto the still-moist paste dot. The nonwoven fabric is gently beaten in order to remove excessive powder that has not adhered to the paste dot. The coating weight of the heat-activated thermoplastic adhesive component is 5 g/m² (=10% by weight, relative to the total weight of the non-dried adhesive compound containing all of the components). The printed nonwoven fabric is dried for 90 seconds at 130° C. [266° F.] in an air-circulating oven. The coating weight of the adhesive compound after drying is 25 g/m².

### Example 5

145 grams (=49% by weight, relative to the total weight of the non-dried adhesive compound containing all of the components) of an aqueous dispersion of a copolymer on the basis of an acrylic acid ester having a minimum film-forming temperature of about 0° C. [32° F.], DIN 53787, a solids content of 60% and high stickiness as well as 70 grams (=23.4% by weight, relative to the total weight of the adhesive compound containing all of the components) of pulverulent thermoplastic copolyamide (melting range from 90° C. to 160° C. [194° F. to 320° F.]) as the heat-activated thermoplastic adhesive component are added to 75 grams of water at room temperature. Then 8.5 grams of a copolymer consisting of polyacrylate/acrylamide as an aqueous dispersion having a solids content of 33% are stirred in as the thickener. Following a stirring time of 30 minutes and a maturing time of 24 hours, the paste is printed by means of the paste-printing method (rotary screen printing) using a doctor blade through a perforated template (CP 180, hole diameter of 0.43 mm) onto a substrate fabric, which is a staple fiber nonwoven that has been thermally bonded in a PS process, that has a mass per unit area of 17 g/m², and that consists of 85% polyamide fibers and 15% polyester fibers. The printed nonwoven fabric is dried for 90 seconds at 130° C. [266° F.] in an air-circulating oven. The coating weight of the adhesive compound after drying is 20 g/m². The fused layer of the interfacing material thus created is covered on both sides with silicone-coated paper.

### Example 6

290 grams (=50% by weight, relative to the total weight of the non-dried adhesive compound containing all of the components) of an aqueous dispersion of a copolymer on the basis of an acrylic acid ester having a glass transition temperature Tg=−43° C. [−45.4° F.] (DSC), a minimum film-forming temperature of approximately <1° C. [33.8° F.], DIN ISO 2115, a solids content of 69% and high stickiness are added as the contact adhesive to 150 grams of water at room temperature. Then 120 grams (=21% by weight, relative to the total weight of the non-dried adhesive compound containing all of the components) of a heat-activated adhesive on the basis of a copolyamide (melting range from 90° C. to 160° C. [194° F. to 320° F.]) are stirred into the mixture. Subsequently, 15 grams of a copolymer consisting of polyacrylate/acrylamide as an aqueous dispersion having a solids content of 33% are stirred in as the thickener. Following a stirring time of 30 minutes and a maturing time of 24 hours, the paste is printed by means of the paste-printing method (rotary screen printing) using a doctor blade through a perforated template (CP 180, hole diameter of 0.43 mm) onto a substrate fabric, which is a fabric that consists of 100% PES and that has a mass per unit area of 44 g/m². The printed nonwoven is dried for 120 seconds at 130° C. [266° F.] in an air-circulating oven. The coating weight of the adhesive compound after drying is 30 g/m².

The fusible interfacing according to the invention as presented in Examples 1 to 6 and in Comparative Example 1a are glued to various difficult-to-fuse outer fabrics using a through-feed fusing press (Veit-Kannegiesser Multistar DX 1000 C/T/TA, manufactured in 2005, serial number DX 100045) at a temperature of 120° C. [248° F.], a pressure of 2.5 bar (=2.5×10⁵N/m²) for 12 seconds.

Outer fabric 1 is a woven fabric made of 100% polyester having a mass per unit area of 23 g/m². This woven fabric is a lightweight, transparent, anthracite-colored chiffon fabric with a porous material structure into which folds have been fused.

Outer fabric 2 is a woven fabric made of 65% cotton and 35% polyester having a mass per unit area of 175 g/m². This woven fabric has a highly water-repellant finish.

Outer fabric 3 is a woven fabric in the form of canvassing consisting of 41.5% cotton, 4% wool, 12% goat hair, 38.5% viscose, 4% polyester; the warp is made of cotton; the weft is made of wool/goat hair/viscose/polyester; mass per unit area of 220 g/m².

The delamination strength is measured according to DIN 54310:1980, with a divergent specimen size (test specimen: 150 mm×50 mm, test fabric: 160 mm×60 mm) and a drawing-off speed of 150 mm/min after fusing with a Veit-Kannegiesser Multistar DX 1000 C/T/TA fusing press. In Example 6, the delamination strength is measured after fusing on a steam-shaping press manufactured by Hofmann Maschinen GmbH of Cologne-Mulheim, Germany type HR 2A-04-04/011E, with saturation steam at 102° C. [215.6° F.], at 3 bar over 15 seconds.

The delamination strength after laundering is measured according to DIN 54310:1980, with a divergent specimen size (test specimen: 150 mm×50 mm, test fabric: 160 mm×60 mm) and a drawing-off speed of 150 mm/min after fusing with a Veit-Kannegiesser Multistar DX 1000 C/T/TA fusing press following laundering according to EN ISO 6330:2000 (method 2A, 60° C. [140° F.]). In Example 6, the delamination strength is additionally measured after fusing on a steam-shaping press manufactured by Hofmann Maschinen GmbH of Cologne-Mulheim, Germany type HR 2A-04-04/011E, with saturation steam at 102° C. [215.6° F.], at 3 bar over 15 seconds.

The delamination strength after dry-cleaning is measured according to DIN 54310:1980, with a divergent specimen size (test specimen: 150 mm×50 mm, test fabric: 160 mm×60 mm) and a drawing-off speed of 150 mm/min after fusing with a Veit-Kannegiesser Multistar DX 1000 C/T/TA fusing press as well as following dry-cleaning according to DIN 54310:1980, DIN EN 3175-2:1998. In Example 6, the delamination strength is measured after fusing on a steam-shaping press manufactured by Hofmann Maschinen GmbH of Cologne-Mulheim, Germany type HR 2A-04-04/011E, with saturation steam at 102° C. [215.6° F], at 3 bar over 15 seconds. Delamination values at which the substrate material tears during the delamination force test are classified as better adhesive values than mean values at which the adhesive compound becomes detached without the substrate material tearing, and they are thus given preference.

Tables 1 and 2 show the delamination strength values after fusing (primary adhesion) following laundering at 60° C. [140° F.] and after dry-cleaning For this purpose, the fusible interfacings in Examples 1 to 6 made with adhesive compound according to the invention were tested.

TABLE 1

| | | Delamination | |
|---|---|---|---|
| | | strength after fusing* | Delamination |
| | | and after being | strength after fusing* |
| | Delamination | laundered one time | and after being dry- |
| | strength after fusing* | at 60° C. [140° F.] | cleaned one time |
| Example 1 | 6.8 N delamination | 3.6 N mean value | 8.1 N mean value |
| Outer fabric 1 | | | |
| Comparative Example 1a | 5.1 N mean value | 1.2 N mean value | 1.3 N mean value |
| Outer fabric 2 | | | |
| Example 2 | 4.5 N delamination | 3.5 N mean value | 4.1 N mean value |
| Outer fabric 2 | | | |
| Example 3 | 14.7 N delamination | 9.7 N delamination | 9.2 N delamination |
| Outer fabric 2 | | | |
| Example 4 | 6.0 N delamination | 10.0 N mean value | 4.2 N mean value |
| Outer fabric 2 | | | |
| Example 5 | 7.3 N delamination | 6.2 N delamination | 3.8 N delamination |
| Outer fabric 2 | | | |
| Example 6 | 5.4 N mean value | 4.1 N mean value | 2.6 N mean value |
| Outer fabric 2 | | | |

*Fusing at 2.5 bar, 120° C. [248° F.] and 12 seconds.

TABLE 2

| | | Delamination | Delamination |
|---|---|---|---|
| | | strength after fusing* | strength after |
| | Delamination | and after being | fusing* and after |
| | strength after | laundered one time | being dry- |
| | fusing* | at 60° C. [140° F.] | cleaned one time |
| Example 6 | 4.5 N mean | 3.1 N mean value | 2.6 N mean value |
| Outer fabric 3 | value | | |

*On a steam-shaping press, saturation steam, 3 bar, 15 seconds.

### Comparative Example 1a

The staple-fiber nonwoven fabric having a mass per unit area of 24 g/m² is printed on with an aqueous paste from the current state of the art containing only heat-activated adhesive powder as the adhesive compound and consisting of the following components: 200 grams of water, 300 grams (=59% by weight, relative to the total weight of the non-dried paste containing all of the components) of copolyamide powder (melting range from 90° C. to 160° C. [194° F. to 320° F.]), 7 grams of thickener, 1 gram of sodium hydroxide, and subsequently dried for 60 seconds at 130° C. [266° F.] in an air-circulating oven. The coating weight of the adhesive compound after drying is 25 g/m².

### Discussion of the Results

After being fused onto difficult-to-fuse outer fabrics 1 to 3, the interfacing fabrics provided with the adhesive compound of the invention according to Examples 1 to 6 yield consistently good care treatment-resistance (delamination strength after laundering at 60° C. [140° F.] and dry-cleaning) and good adhesion (delaminating force) at a value of more than 1.5 N measured according to DIN 54310:1980, with a divergent specimen size (test specimen: 150 mm×50 mm, test fabric: 160 mm×60 mm) after fusing with a Veit-Kannegiesser Multistar DX 1000 C/T/TA.

In contrast, interfacing according to the current state of the art, as shown in Comparative Example 1a, does not exhibit sufficient adhesion (delamination strength) after dry-cleaning and laundering at 60° C. [140° F.] following fusing onto the critical outer fabric 2.

After having been properly fused onto a textile outer fabric, the interfacing materials provided with the adhesive compound according to the invention, as shown in Examples 1 to 6, exhibit a good appearance and feel. The adhesive compound according to the invention as shown in Example 1 does not soak through the holes, even in the case of the very thin and lightweight outer fabric 1 having an open, porous material structure, and it is not visible as shininess or as a color difference on the outside of the outer fabric after the fusing.

A canvas-like structure according to Example 6 displays excellent delamination strength and care treatment-resistance while being easy to process, since it adheres to the outer fabric in three-dimensional form at room temperature and can be permanently fused during the steam shaping procedure, so that there is no need for additional seams for the fusing. It allows the production of canvas-like structures that retain their three-dimensional shape very well after care treatments.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the attached claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B.” Further, the recitation of “at least one of A, B, and C” should be interpreted as one or more of a group of elements consisting of A, B, and C, and should not be interpreted as requiring at least one of each of the listed elements A, B, and C, regardless of whether A, B, and C are related as categories or otherwise.

1. An adhesive compound for fusible interfacing comprising:
a heat-activated thermoplastic adhesive (component A) that is not sticky at room temperature: and
a contact adhesive (pressure-sensitive adhesive) that is tacky at room temperature (component B),
wherein a proportion of component (A) is 5% to 40% by weight, preferably 10% to 30% by weight, relative to a total weight of a non-dried adhesive compound comprising all components, and
wherein a proportion of component (B) is 30% to 95% by weight liquid, relative to the total weight of the non-dried adhesive compound comprising all of the components.

2. The adhesive compound of claim 1, wherein the component (A) comprises a copolyester, copolyamide, polyolefin, or a mixture of two or more of any of these.

3. The adhesive compound of according claim 1, wherein the component (B) is present as an aqueous polymer dispersion, polymer emulsion, or an aqueous polymer dispersion and a polymer emulsion.

4. The adhesive compound of claim 1, comprising less than 25% of an additive comprising a cross-linking agent, resin, wetting agent, thickener, plasticizer, pigment dye, or a mixture of two or more of any of these.

5. An interfacing comprising the adhesive compound of claim 1.

6. The interfacing of claim 5, wherein relative to the total weight of the on-dried adhesive compound comprise g all of the components, the adhesive component comprises
10% to 30% by weight of a copolyester copolyamide, polyolefin, or a mixture of two or more of any of these, and
30% to 95% by weight liquid of a styrene-butadiene copolymer, acrylic acid ester copolymer, or a mixture of two or more of any of these.

7. A woven, knit, non-woven, shoulder padding, brassiere cup, or canvas-like structure, comprising the interfacing of claim 6.

8. A method for fusing an interfacing provided with the adhesive compound of claim 1, the method comprising:
applying the adhesive compound onto a width of substrate material;
removing water from the adhesive compound by hot air drying, to obtain a dried adhesive compound;
fusing the interfacing onto a textile outer fabric by a pressure from 0 N/m² to 8×10⁵ N/m² and at a temperature ranging from 60° C. to 160° C. [140° F. to 320° F.] over a period of 5 seconds to 120 seconds.

9. The method of claim 8, further comprising:
covering the dried adhesive compound with a film or release paper; and
removing the covering prior to fusing the interfacing.

10. The adhesive compound of claim 1, wherein the proportion of component (A) is 10% to 30% by weight, relative to the total weight of the non-dried adhesive compound comprising all of the components.

11. The adhesive compound of claim 1, wherein the proportion of component (B) is 50% to 90% by weight liquid, relative to the total weight of the non-dried adhesive compound comprising all of the components.

12. The adhesive compound of claim 10, wherein the proportion of component (B) is 50% to 90% by weight liquid, relative to the total weight of the non-dried adhesive compound comprising all of the components.

13. The adhesive compound of claim 1, wherein the component (A) comprises, in polymerized form, an acrylic acid ester, vinyl acetate, ethylene, styrene-butadiene copolymer, polyurethane, or a mixture of two or more of any of these.

14. The adhesive compound of claim 4, comprising less than 5% of the additive.

15. The adhesive compound of claim 1, wherein the component (A) comprises a copolyester.

16. The adhesive compound of claim 1, wherein the component (A) comprises a copolyamide.

17. The adhesive compound of claim 1, wherein the component (A) comprises a polyolefin.

18. The adhesive compound of claim 1, wherein the component (A) comprises a copolymer comprising an acrylic acid ester.

19. The adhesive compound of claim 1, wherein the component (A) comprises a copolymer comprising vinyl acetate.

20. The adhesive compound of claim 1, wherein the component (A) comprises a copolymer comprising ethylene.
